(19) United States
(12) Patent Application Publication
(10) Pub. No.: US 2022/0156271 A1
(43) Pub. Date: May 19, 2022

(54) SYSTEMS AND METHODS FOR DETERMINING THE PROBABILITY OF AN INVENTION BEING GRANTED A PATENT

(71) Applicant: VETTD, INC., Bellevue, WA (US)

(72) Inventors: Andrew Buhrmann, Bellevue, WA (US); Michael Buhrmann, North Bend, WA (US); Ali Shokoufandeh, New Hope, PA (US); Devin Miller, Bellevue, WA (US)

(21) Appl. No.: 17/578,239

(22) Filed: Jan. 18, 2022

Related U.S. Application Data
(63) Continuation-in-part of application No. 17/397,757, filed on Aug. 9, 2021.
Application No. 17/397,757 is a continuation-in-part of application No. 16/600,847, filed on Oct. 14, 2019.
Application No. 16/600,847 is a continuation-in-part of application No. 17/148,344, filed on Jan. 13, 2021.
Application No. 17/148,344 is a division of application No. 14/952,495, filed on Nov. 25, 2015, now Pat. No. 11,003,671.
(60) Provisional application No. 63/138,287, filed on Jan. 15, 2021.
(60) Provisional application No. 62/745,186, filed on Oct. 12, 2018.
(60) Provisional application No. 62/215,976, filed on Sep. 9, 2015.
(60) Provisional application No. 62/084,836, filed on Nov. 26, 2014.

(51) Int. Cl. G06F 16/2457; G06F 16/248; G06F 16/28; G06F 16/2452; G06F 16/36; G06F 16/33; G06F 40/14; G06Q 10/10

(52) U.S. Cl. CPC G06F 16/24578; G06F 16/248; G06F 16/285; G06Q 10/1053; G06F 16/367; G06F 16/3347; G06F 40/14; G06F 16/24522

(57) ABSTRACT

This invention provides the ability for an inventor to determine the probability of their invention being granted a patent. The invention disclosure and/or any type of patent document is classified before, during or after being filed by using any of the existing classification systems (e.g., CPC codes) or others such as a new and novel business vernacular classification system (as described as part of this disclosure). This newly created invention persona (classified document) is then compared to the existing patent database to discover granted patents that are similar and may be compared to other public and non-public databases to discover prior art. An analysis is then performed using various algorithms pertaining to the similarity of the classification by examining the branches, proximity, density etc. of the various assigned codes which will uncover the novelty, non-obviousness, and utility of the invention disclosure. A further search can then be undertaken to discover the “white spaces’ and the inventor then has the ability to use the analysis and search discovery to adjust the invention to better reflect the “white spaces” for maximum probability of a patent being granted.

### PRIORITY CLAIM

This application claims priority to U.S. Provisional Patent Application Ser. No. 63/138,287 filed Jan. 15, 2021.

This application is also a continuation in part of and claims priority to U.S. patent application Ser. No. 17/397,757 filed Aug. 9, 2021;

This application is a continuation in part of and claims priority to U.S. patent application Ser. No. 16/600,847 filed Oct. 14, 2019 which application claims priority to U.S. Provisional Patent Application Ser. No. 62/745,186 filed Oct. 12, 2018;

This application is a continuation in part of and claims priority to U.S. patent application Ser. No. 17/085,050 filed Oct. 30, 2020 which application claims priority to U.S. Provisional Patent Application Ser. No. 62/928,893 filed Oct. 31, 2019;

This application is a continuation in part of and claims priority to U.S. patent application Ser. No. 17/148,344 filed Jan. 13, 2021, which application is a divisional of U.S. patent application Ser. No. 14/952,495 filed Nov. 25, 2015 (now U.S. Pat. No. 11,003,671 issued May 11, 2021) which claims priority to U.S. Provisional Patent Application Ser. No. 62/215,976 filed Sep. 9, 2015 and U.S. Provisional Patent Application Ser. No. 62/084,836 filed Nov. 26, 2014; and

This application incorporates by reference U.S. patent application Ser. No. 16/011,143 filed Jun. 18, 2018 (now U.S. Pat. No. 11,048,879 issued Jun. 29, 2021), which application claims priority to U.S. Provisional Patent Application Ser. No. 62/647,518 filed Mar. 23, 2018 and U.S. Provisional Patent Application Ser. No. 62/521,792 filed Jun. 19, 2017. The contents of each of the foregoing applications and patents are hereby incorporated by reference in their entirety as if fully set forth herein.

### COPYRIGHT NOTICE

This disclosure is protected under United States and/or International Copyright Laws. © 2022 Vettd, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND

A vast amount of money and resources is expended in the prosecution of a patent. The process of securing a patent through a governmental granting body is a lengthy and costly process that includes researching, drafting, filing, and negotiating the rights for an invention. There are no guarantees when prosecuting a patent that the patent will be approved or that one will receive the rights that one set out to claim were part of the invention.

Time and money could be saved by the inventor and/or assignee if they have knowledge of the probability of their patent application on their invention being granted a patent. The granting of a patent has predetermined characteristics such as novelty (uniqueness), non-obviousness, and utility. The probability of a patent being granted can be modified by editing various sections including specification, drawings, embodiments, claims, and etc. Also, knowing where the “white spaces” between the invention and the prior art exist (if they do) will help with drafting the claims to increase the probability.

There are patent search engines and techniques available today to search for prior art, but they are primarily based on key words and Boolean methodologies. The use of these technologies is labor intensive and at the mercy of the particular practitioner, and hence prone to inconsistency and potential future litigation.

### BRIEF DESCRIPTION OF THE DRAWING FIGURES

FIG. 1 illustrates the overall process of the invention;

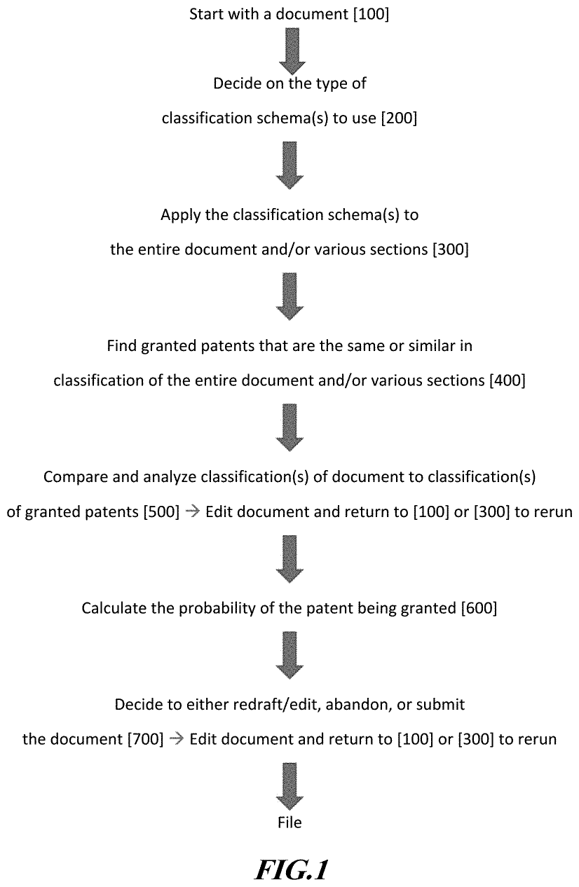

FIG. 2 Business Vernacular Code classification for CPC code H4M01;

FIG. 3 illustrates the screen for a typical user search;

FIG. 4 illustrates the return of the invention's calculated probability of success along with patents that are highly significant;

FIG. 5 illustrates additional detail on patentability likelihood from the invention analysis in support of the probability score.

### DETAILED DESCRIPTION

The invention determines the probability of an invention being granted a patent. An invention persona is first created through the use of classifiers. The classifier schema can use CPC codes, international codes, etc. or, as described further, a novel business vernacular classification system (the “Business Vernacular Codes” or “BVC”), either separately or in combination. It can be applied to any document including those listed in section [100].

The benefit of this invention is that it can provide confidence (or not) that the invention disclosure has the qualities of novelty, non-obviousness and utility and that it has some probability of having some or all of the claims granted.

Any document can be used. For this case we are using documents related to patents. The document can be an invention disclosure, provisional patent application, published application, granted patent, rejected patent, abandoned patent etc. In addition, these documents can be in draft form or final. For the patent use case there are:

[110] Draft Invention Disclosure

[120] Invention Disclosure

[130] Draft Provisional Patent

[140] Provisional Patent Application

[150] Draft Standard Patent

[160] Standard Patent Application

[170] Published Patent

[180] Granted Patent

[190] Abandoned Patent

[200] Decide on the Type of Classification Schema(s) to Use

There are several different types of classification schemas: Public, Unique (purpose built), Personal or Combinations.

[210] Public Classification Schemas

CPC Codes

International Codes

Other national or international codes used by government patent agencies

[220] Unique or Purpose-Built Schemas:

Business Language Codes (BVC)—A new type of classification based not on what the invention is but how it is applied or used in business and or industry; a.k.a. describing the utility of the invention.

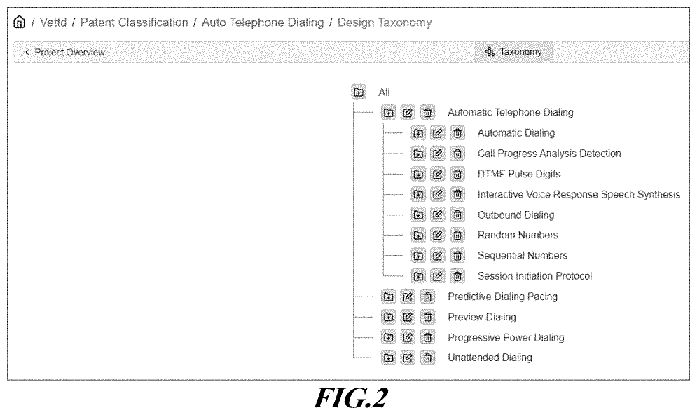

This new type of classification system is also claimed in this patent. BVC consists of using classifications/labels that are based on business language usage of inventions that have already been granted patents. These labels speak to how the patent can be used in industry as opposed to the CPC codes which labels the patent invention according to where it most closely fits within the hierarchical CPC code structure of what the invention is. By using subject matter experts and others, AI models can be trained, and patents can then be classified under the BVC system. This is a unique classification system and has other business uses (e.g. patent audits for M&A). See FIG. 2.

[230] Private Schema:

Keys words, document titles,

Number of words separating Key words

[240] Combination of Public and/or Unique and/or Private.

[300]—Apply the Classification Schema(s) to the Entire Document and/or Various Sections

The method of classification is accomplished by the use of orchestrated neural networks. In order to apply CPC codes before they are assigned by a patent office/examiner, various AI models have been developed.

The models are trained using the CPC codes assigned to patents that are already granted. Using the inventor's intelligent neural orchestration, smaller data sets are used to get a very high accuracy level, down to the subclass group.

For an invention disclosure [110, 120], the entire document is classified by the model and then compared to other granted patents that use the same CPC or international or unique BVC codes [220].

For a provisional and other patent documents [130-190], the entire document is classified by the model and then compared to other granted patents that use the same CPC or international or business language codes [220]. In addition, each section of the provisional and other patent documents [130-190] are also individually classified. These sections include but are not limited to:

the abstract,

the background,

the invention summary,

the embodiment,

the claims

Likewise, other classifications such as unique or custom-built schemas such as the Business Language Code classifiers [220] can also be applied to the entire document and/or to individual sections.

[225] Classify the same as any individual patent examiner would.

[300] Apply the classification Schema(s) to the entire document and/or various sections;

[400] Find granted patents that are the same or similar in classification of the entire document and/or various sections

[410] Using conceptual relatedness search for already granted patents that are similar to the document under consideration.

[420]—Searching for Prior Art with preassigned CPC codes plus cited reference recommendations.

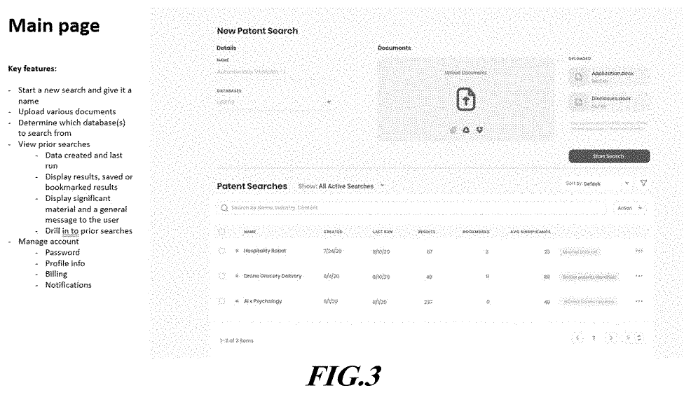

FIG. 3 illustrates the screen for a typical user search. Here the user is interested in a new patent on autonomous vehicle. The autonomous vehicle language is drafted and loaded. In the background, the invention examines the language and determines applicable CPC codes likely to be assigned. The database of patents is then examined to narrow down the patents with applicable CPC codes and relevant claims. The user then has a concise list of patents to further look into.

[430] Searching for Novelty and/or Non-obviousness a.k.a. “Finding the White Space.” The patents that are the most like the invention disclosure can then be analyzed on the basis of the proximity or and/or density or number of branches of the classification system (e/g. sub classes involved). An iterative process can be used to adjust the claims to find the white space.

[440] Search by individual patent examiner.

[500] Compare and Analyze Classification(s) of Document to Classification(s) of Granted Patents

[510] Various types of comparisons can be made.

[511] The entire document to other patents—For the entire document (the document as a whole) under consideration [110-190], the classification [210-240] of the document can be compared to the classifiers [210-240] assigned to the documents [110-190] contained in both public and private patent databases.

For public databases such as the USPTO, this information is readily available. For private databases such as from a legal firm or enterprises, they may first need to be classified themselves using the process [100-300].

[521] Sections of the document to sections of other patents—This allows the comparison of the abstract of the document under consideration to the abstract of all the other abstracts found in {110-190] in both public and in private databases. Likewise, for all the other sections such as background, invention summary, embodiment, claims etc.

Section by section classification for public patents can be accomplished by either assigning the same overall classification of the patent to the individual sections or by reclassifying them using the techniques as described in [100-300] or both for additional comparison purposes.

For private databases such as from a legal firm or enterprises, they will first need to be classified using the technique as described in [100-300].

[513] Sections of the document to the other sections of the same document—do they have the same classification

[520] Various types of analyses can be made

[521] Analysis of CPC codes for the entire document under consideration to the CPC codes found in the comparison.

Determine if the classification codes are the same, overlay or are they completely different.

Same classification

Some overlap

Completely different

[522] Perform the same analysis for each of the sections of the document under consideration to the CPC codes found in each of the sections of the patent found that are similar

[540] White Space Analysis—

[530] Edit or Redraft Document—Any deviations in the classification codes assigned to the various sections may be an indication of a lack of coherency between the sections. The provisional sections can then be edited or redrafted until the classification of each section is the same.

The entire provisional patent submittal is then classified as a whole based on a calculation of whether the classifications of each section are the same and where they differ and then calculating the weighting of the various sections. This is then compared to the classification of the whole patent.

The classified provisional patent can then be compared to the entire classified patent granted database. This comparison may rank those patterns that have the closest classification to the invention under review. Even if not described further, the invention can be used to compare the classified invention disclosure or provisional patent against other public and non-public databases to discover prior art.

With explainable AI, even when changing patent attorneys (or patent examiners), consistency can be maintained, and the underlying classification models explained. This is be important for future litigation when larger ML models may be challenged on their classification method and rationale.

[600] Calculate the Probability of the Patent being Granted

At any time in the process a probability score can be calculated. Factors to include are, but not limited to:

[610] Is the classification overlay completed or not at all or somewhere in between?

[620] What is the variation of the codes? All in the same subgroup or spread out?

[630] Is there one classification code or many at each level in the hierarchy?

[640] Are they density clustered or widely dispersed?

[650] Do they have a single or multiple parent?

[660] Are the codes all in one family (A to H) or two or three etc.

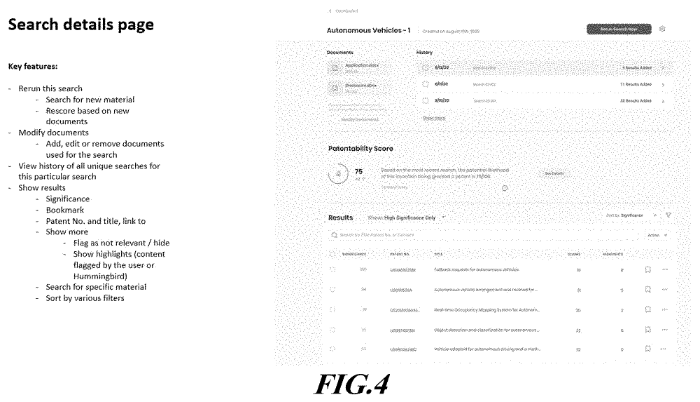

FIG. 4 returns the invention's calculated probability of success along with patents that are highly significant. Each of these patents are assigned a significance score based on relatedness between the patent's CPC codes and claims and the invention write up being examined.

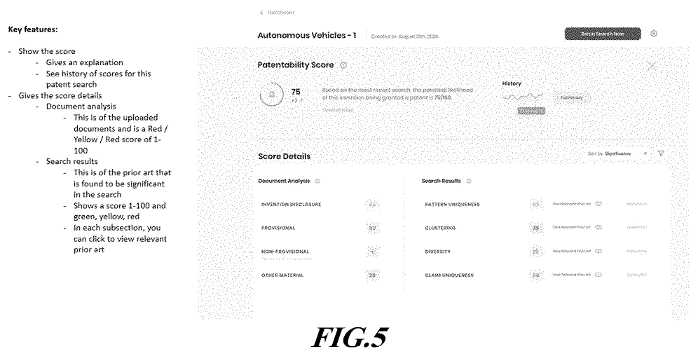

FIG. 5 illustrates additional detail on patentability likelihood from the invention analysis in support of the probability score.

[700] Decide to either redraft/edit, abandon, or submit the document

[710] Based on the probability calculation of the patented being granted as determined in section [600] the document can be either redrafted/edited, abandoned or submitted to the next step in the process

[710] For a Draft Invention Disclosure [110]—Based on the probability and other factors as determined by the inventor or assignee, the document can be either redrafted/edited, abandoned or submitted to the next step in the process.

[720] Invention Disclosure [120]—Based on the probability and other factors as determined by the inventor or assignee, the document can be either redrafted/edited, abandoned or submitted to the next step in the process.

[730] Draft Provisional Patent [130]—Based on the probability and other factors as determined by the inventor or assignee, the document can be either redrafted/edited, abandoned or submitted to the next step in the process.

[740] Provisional Patent Application [140]—Based on the probability and other factors as determined by the inventor or assignee, the document can be either redrafted/edited, abandoned or submitted to the next step in the process.

[750] Draft Standard Patent [150]—Based on the probability and other factors as determined by the inventor or assignee, the document can be either redrafted/edited, abandoned or submitted to the next step in the process.

[760] Standard Patent Application [160]—office rejections can be analyzed in light of an independent CPC review. Further arguments can be made on the correct application of the CPC codes and new cited references etc.

[770] Published Patent [170]—verify correct usage of CPC codes.

[780] Granted Patent [180]—for use in litigation.

[790] Abandoned Patent [190]—use for training and create a database for comparison and use in probability calculation.

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. The preferred embodiment describes a patent use case. This invention could also apply to, for example, but not limited to: candidate applications for education.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A method of determining the probability of a patent being granted.

2. The method of claim 1, further comprising determining the CPC classifications codes prior to them being assigned by the patent office and assigning classification code(s) prior to submittal of a provisional patent to a Government Patent Office.

3. The method of claim 1 further comprising a process to facilitate the evaluation of a provisional patent to more correctly position the provisional with the Examiner by accentuating the uniqueness, non-obviousness and utility of the invention through CPC code analysis.

4. The method of claim 1, further comprising assigning, examining and analyzing CPC codes for one or more individual sections of a provisional patent selected from the group of sections comprising the abstract, background, invention summary, embodiments, and claims.

5. The method of claim 1, further comprising a process to facilitate the congruency of a patent application by comparing the classification of its individual sections to each other, wherein the process allows a user to review the integrity of the individual sections to each other and to the patent as a whole thereby providing guidance for editing and redrafting either the individual sections or the entire provisional application.

5. The method of claim 1, further comprising ranking granted patents to their conceptual relatedness to the subject provisional patent in their entirety and by section allowing for the discovery of relevant prior art and cited references.

6. A business vernacular classification system comprising assigned CPC codes based on what a patented invention might be used for in one or more of industry or business.

7. The method of claim 6, further comprising white space pattern analysis of the assigned CPC codes in terms of prior art overlap, proximity, density, and separation within and between branches to uncover the novelty and non-obviousness of an invention.
